(19) United States
(12) Patent Application Publication
(10) Pub. No.: US 2003/0200265 A1
(43) Pub. Date: Oct. 23, 2003

(54) Electronic mail address validation

(76) Inventor: Steven G. Henry, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/125,978

(22) Filed: Apr. 19, 2002

(51) Int. Cl. G06F 15/16

(52) U.S. Cl. 709/206

(57) ABSTRACT

A transmitter device receives an email address selected by a user. The transmitter device retrieves a validation status of the email address from a resource on an interconnecting network. The transmitter device sends message data to the email address if the retrieved validation status indicates the validity of the email address.

### FIELD OF THE INVENTION

The present invention relates generally to peripheral devices and more particularly to the validation of an electronic mail (email) address.

### BACKGROUND OF THE INVENTION

Many peripherals to computer networks include a scanner component. One example of such a peripheral is an “all-in-one”, also known as a multifunction peripheral (MFP) in that it has the capability to perform the multiple functions of scanning hardcopy documents, copying, and printing. Another example is a digital network copier that scans in documents from an automatic document feeder, does high volume copying, and has the capabilities of binding, collating, folding, stacking, stapling, stitching, edge-trimming, paginating, and printing on substrates of varied composition. Each of these peripherals, when in communication with an interconnecting network, can also be described as being a transmitter device. A transmitter device is an appliance that has a keyboard, a display, and a scanner. The transmitter device need not have a printer. A digital camera is a type of transmitter device, but in comparison to the foregoing, it is not as useful for handling documents and typically lacks the resolution and ability to rapidly and repetitively transfer information after scanning to a repository.

In an exemplary digital transmitting operation, a hardcopy of a document can be presented to the scanner portion of a transmitter device. After scanning, the transmitter device transforms the scanned image into a digital representation of the document that is then saved in a data format, such as in a bit map data format or in a Portable Document Format (PDF). Electronic messaging can be used to send an electronic mail (email) from the transmitter device with an attachment of the document in one of several data formats. The email can be sent to a recipient over the interconnecting network, where the recipient has an email address that a user manually enters at the transmitter device or that the user specifies using a defined list of recipient email addresses.

It is possible that the manually entered email address or the selected email address from the defined list of recipient email addresses is invalid. The user transmits to the invalid email address only to find out, after a period of time, that the email was not delivered due to the invalid email address. In many cases, the user may never find out unless they directly contact the recipient. Thus, the user will not know in advance whether or not the email address is valid prior to sending the document attached to the transmitted email. It would be beneficial to minimize misdirected email or email that will not be delivered due to the specification of an invalid email address. Consequently, there is a need for improved methods, apparatuses, systems, and programs that can provide such a capability.

### SUMMARY OF THE INVENTION

The above-stated needs and/or others are met, for example, by methods, apparatuses, systems, and programs that use an input device, such as a touch sensitive menu screen, to receive input from a user. The input identifies an email address on an interconnecting network with which the transmitter device is in communication. The transmitter device retrieves a validation status of the email address from a resource on the interconnecting network. The transmitter device will send message data to the email address if the retrieved validation status indicates the validity of the email address.

These and other features of the present invention will become more fully apparent from the following description and appended claims, or may be learned by the practice of the present invention as set forth hereinafter.

### DESCRIPTION OF THE DRAWINGS

A more complete understanding of the various methods, apparatuses, systems, and programs of the present invention may be had by reference to the following detailed description when taken in conjunction with the accompanying drawings wherein the same reference numbers are used throughout the drawings to reference like components and features, and wherein:

FIG. 1 is a block diagram depicting a computing and communication environment having transmitter devices in a system environment suitable for providing local access to the transmitter devices.

FIG. 2 illustrates various transmitter devices that provide local access for input thereto.

FIG. 3 is a block diagram illustrating a transmitter device in communication with an interconnecting network in a system such as that shown in FIG. 1.

FIGS. 4 and 5 illustrate respective examples of menu pages that might be displayed on a touch sensitive menu screen of a transmitter device and transition sequences among the menu pages.

FIG. 6 is a flow diagram depicting a method for use in a computing and communication environment having a transmitter device in a system as in FIG. 1, for example, in accordance with certain exemplary embodiments of the present invention.

### DETAILED DESCRIPTION

The methods, apparatuses, systems, and programs described herein relate to the transmission of message data in an electronic mail (email) from a transmitter device to a specific email address, and to the validation of the email address prior to the transmission. To obtain a specific email address, a user inputs information that can be used by a third party or via the user's own organization to provide back to the user a list of potential address selections. The third party is in communication with the transmitter device through an interconnected network. The third party provides a directory search service that looks up and provides to the transmitter device the desired email address. The transmitter device then retrieves one or more email addresses from the third party over the interconnected network, and the user makes a selection of a specific email address from among the one or more email addresses. Alternatively, the user can input a specific email address, if known, directly into the transmitter device.

Once the specific email address has been specified to the transmitter device, a validation check of the specific email address is performed at the transmitter device using the services of a third party World Wide Web (“Web”) service. The third party is provided with the specific email address from the transmitter device through a communication on the interconnected network. The third party determines whether or not message data will be received by the specific email address. The transmitter device then retrieves the results of this validity check of the specific email address from the third party over the interconnected network. If the validity check is positive, the transmitter device will proceed with a process of sending message data to the specific email address. Otherwise, the transmitter device will display a diagnostic to the user as to the invalidity of the specific email address.

### Exemplary System for Configuration of a Transmitter Device

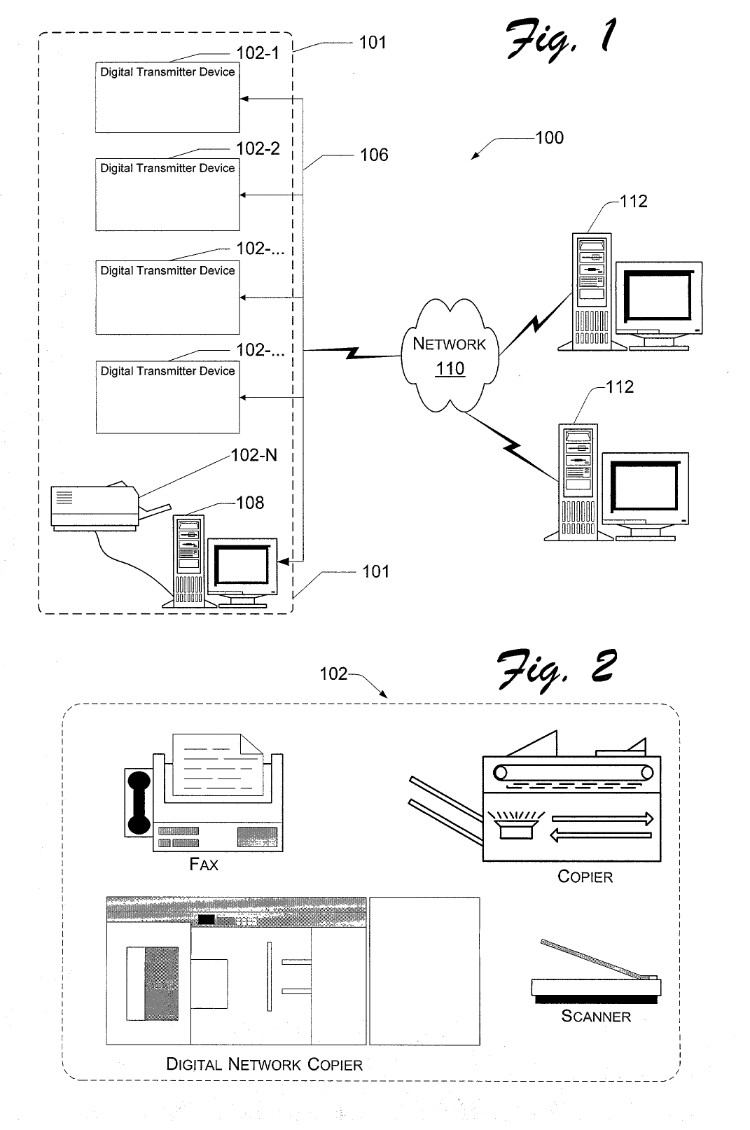

FIG. 1 illustrates an example of a system environment 100 suitable for implementing a process that controls email address validation and transmission from a transmitter device 102. The system environment 100 contemplates local access to an input put device, such as a touch sensitive menu screen, on a transmitter device 102. A user accesses the input device for the purpose of entering information related to a desired email address.

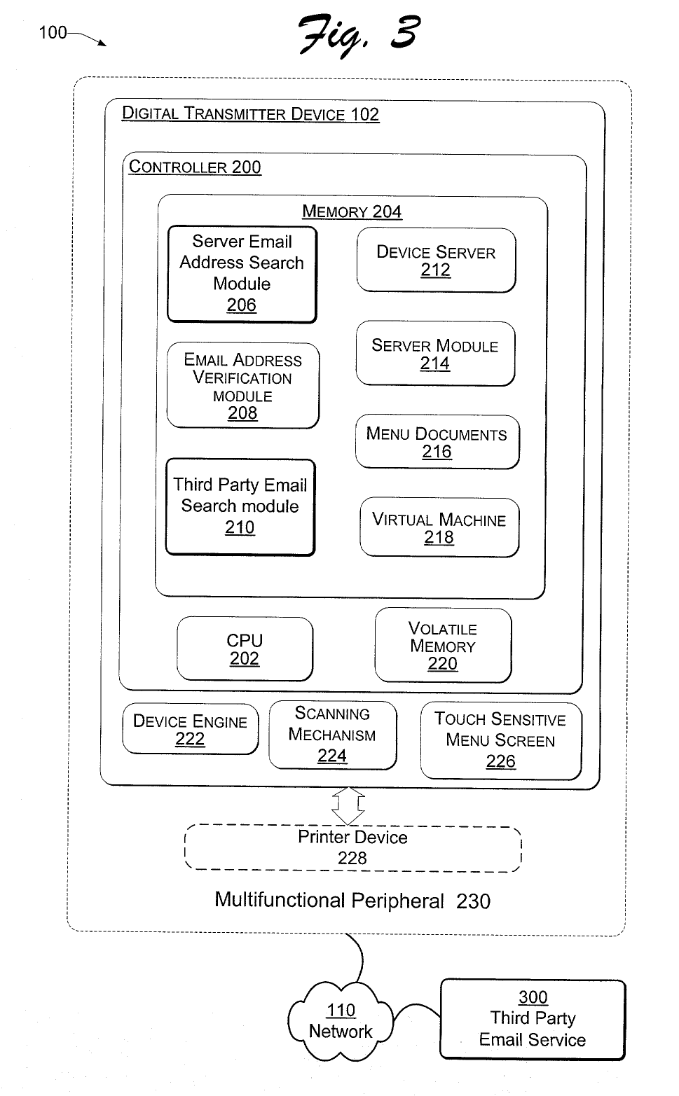

Transmitter devices 102-1 through 102-N generally include peripheral devices and stand-alone devices. Although in FIG. 1 transmitter devices 102-1 through 102-N are shown as digital transmitter devices, transmitter devices 102-1 through 102-N may be analog or digital transmitter devices or a combination of both. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Transmitter devices 102 therefore include devices such as copiers, scanners and fax machines like those shown in FIG. 2.

Transmitter devices 102 are generally distinguishable from devices such as laptop PCs (personal computers) and pocket PCs by their limited purpose and limited user interface or input/output capabilities. For example, a typical user interface for a transmitter device 102 includes a front menu panel with limited screen space and a limited number of buttons. In addition, a transmitter device 102 is typically oriented toward performing one general task such as scanning. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

An interconnecting network 110 is representative of one or more communication links, either wired or wireless, that are capable of carrying data between transmitter device 102 and other network resources in communication with interconnecting network 110. In certain exemplary implementations, interconnecting network 110 includes a local area network (LAN), a wide area network (WAN), an intranet, the Internet, or other similar network. Transmitter device 102, as seen in FIG. 1, is typically coupled to interconnecting network 110 either indirectly to through a host computer 108 in an intranet 101, or through a network connection 106 to interconnecting network 110.

### Exemplary Embodiment of an Apparatus for Implementing Configuration of the Same

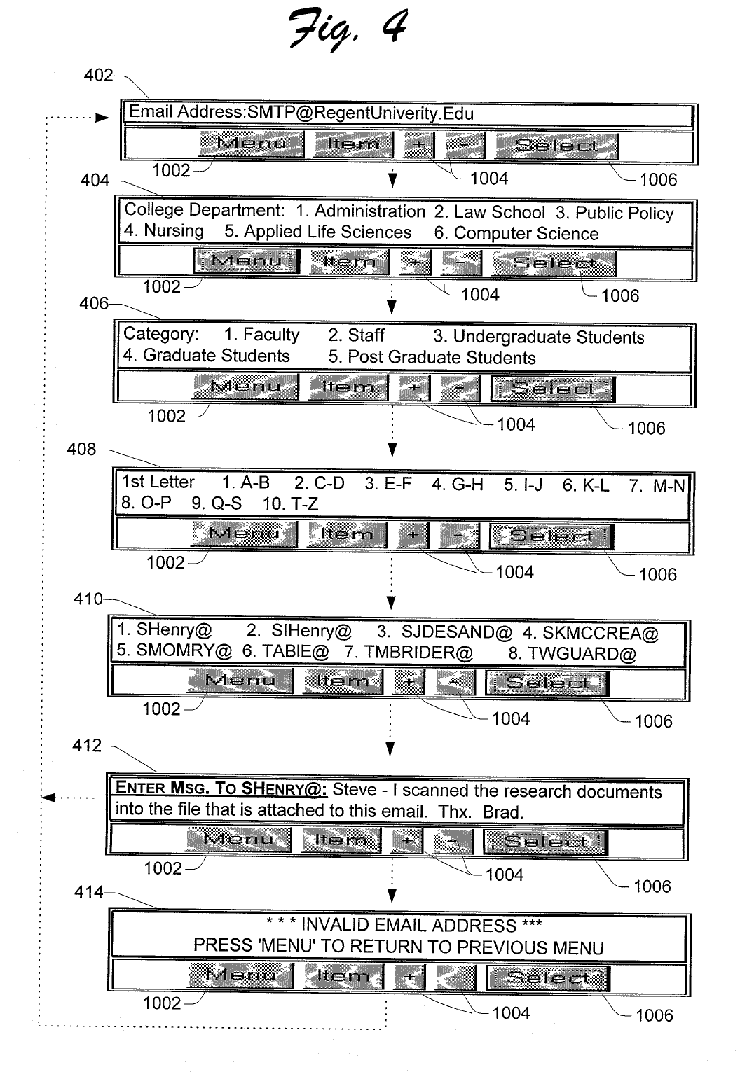

The system 100 of FIG. 3 includes transmitter device 102 as a peripheral device coupled through an interconnecting network 110. As such, FIG. 3 illustrates an embodiment of the system 100 of FIG. 1 in greater detail. In accordance with still other aspects of the present invention, transmitter device 102 may be included within a multiple function peripheral (MFP) device 230. As its name implies, MFP device 230 is configured to provide multiple functions. In this example, the functions provided by MFP device 230 include those provided by transmitter device 102 and a printer device 228. Consequently, the user of transmitter device 102 may also print out a hardcopy of any applicable portions of message data received by transmitter device 102. In general, the host computer 108 seen in FIG. 1 outputs host data to a transmitter device 102 in a driver format suitable for the transmitter device 102, such as PCL or postscript for printer device 228. Printer device 228 converts the host data and outputs it onto an appropriate print media, such as paper, transparencies or glossy photo paper.

Transmitter 102 includes a CPU 202, which is operatively coupled to a memory 204, and a user interface that includes an input device 226. Preferably, the input device 226 will be locally accessible at transmitter device 102. By way of example, the input device 226 can be a touch sensitive menu screen. Transmitter device 102 also includes a scanning mechanism 224 and at least one communication port for interfacing with the interconnecting network 110. When included in a multifunctional peripheral (MFP) device 230, CPU 202 would also be operatively coupled to a printer device 228, for example. CPU 202 is representative of any hardware, firmware and/or software that is configured to perform certain functions associated with the operation of transmitter device 102 and, if applicable, MFP 230. Hence, as those skilled in the art will recognize, CPU 202 may include dedicated logic and/or one or more processors configured in accord with software instructions, for example.

Memory 204 is representative of any type of data storage mechanism that can be accessed by at least CPU 202. Memory 204 may therefore include, for example, some form of random access memory (RAM); some form of read only memory (ROM), and/or other like solid-state data storage mechanism. Memory 204 may include a magnetic and/or optical data storage mechanism. Scanning mechanism 224 is representative of any optical scanner technology that may be employed to produce scanned object data upon scanning an object. Such scanning technologies are well known. The resulting scanned object data is provided to CPU 202 and/or stored in memory 204.

The peripheral or transmitter device 102 has a controller 200 that can process data from host computer 108. The controller 200 typically includes data processing unit or CPU 202, a volatile memory 220 (i.e., RAM), and a non-volatile memory 204 (e.g., ROM, Flash). Transmitter device 102 also includes a device engine 222. The touch sensitive menu screen 226 acts as a local user interface for transmitter device 102 by displaying menu pages and accepting user input based on selectable menu items displayed on the menu pages. The touch sensitive menu screen 226 can be used to display a menu page that asks for and receives input needed to validate and transmit message data to an email address from transmitter device 102.

A device controller 200 processes host data and manage device functions by controlling a device engine 222 and by responding to input from a touch sensitive menu screen 226. Controller 200 includes device driver software in a device server 212 that is stored in a memory 204 and executed on a processor, such as a CPU(s) 202. Memory 204 also includes a server module 214 configured to serve menu documents 216 to the touch sensitive menu screen 226. The server module 214 is a local server in the sense that it is present within the same transmitter device 102 to which it serves menu documents 216. Menu documents 216 are interpreted by the server module 214 and are configured to display textual and graphical information as menu pages on the touch sensitive menu screen 226.

Graphical keys or buttons presented on menu pages that are displayed by the touch sensitive menu screen 226 offer selectable menu items that are described by accompanying textual information. Menu documents 216 driving the menu pages include embedded code associated with graphical keys. Selecting a menu item by pressing a graphical key on the touch sensitive menu screen 226 triggers an event which causes a “virtual machine” 218 to interpret and execute the code associated with the selected graphical key. The virtual machine 218 is a software module stored in memory 204 that executes on CPU(s) 202 to interpret and execute code. The code can be a script code that is written in JavaScript™ code and that is interpreted and executed on a Java™ Virtual Machine (JVM). The script code can also be written in ChaiServer™ code that is interpreted and executed on a Chai™ Virtual Machine. The script code can also be written in other script code languages such as VBScript or Perl. However, the code can also be written in other software or machine languages including but not limited to C++ or C#. Alternatively, the algorithms can be resident in the machine and programmed in any common embedded processor code.

The code associated with selectable menu items (i.e., graphical keys or buttons) is configured to perform the task of receiving input related to the retrieval of a specific email address to which message data is to be transmitted from transmitter device 102. When so received and retrieved, the code associated with selectable menu items will initiate an email address information retrieval routine using the services of a server or other storage location, such as host computer(s) 112 that is also in communication with interconnecting network 110.

A server module on host computer 112 acts as a remote server to the transmitter device 102, providing data that contain email address information that is requested by transmitter device 102. When the email address information is retrieved from the host computer(s) 112, the user inputs a selection of one or more of the email addresses that is received from the server module on host computer 112. Alternatively, the user can directly enter one or more specific email addresses into the transmitter device 102.

Once the transmitter device 102 has received input from the user as to a specific email address, the code executing on CPU 202 of transmitter device 102 then initiates email address validation routine to ascertain whether or not the specified email address is valid for interconnecting network 110. The email address validation routine uses the services of a server or other storage location, such as host computer(s) 112 that is also in communication with interconnecting network 110. The server provides the service of validating the specified email address and returning the result of the validation check back to the email address validation routine in transmitter device 102.

With this in mind, CPU 202 is configured to perform the operations described above using various executable modules of memory 204. A Server Email Address Search Module 206 is implemented in software or firmware, and is configured to provide means for a search of a given recipient's email address by algorithmically transforming the email address that is input by a user at touch sensitive menu screen 226 into the associated server domain by CPU 202. For example, to validate “john_jones@hp.com” the processor uses the domain name hp.com. The Server Email Address Search Module 206 opens a connection in turn with the various server addresses contained in DNS MX records for the domain hp.com. Then, Server Email Address Search Module 206 searches for email address information associated with the given server using the portion of the email address prior to the “@” sign. In this case, the sequence “johnjones” is sent, such as at host computer 112, so as to validate the email addresses according to the given email server. This is done by utilizing the VRFY command as outlined in RFC821 or any other means supported by the external email service. In one embodiment of the invention, the Server Email Address Search Module can supply a list of email address alternatives to the user given a 3^{rd} party directory service or utilizing an in-house directory service such as lightweight directory address protocol (LDAP).

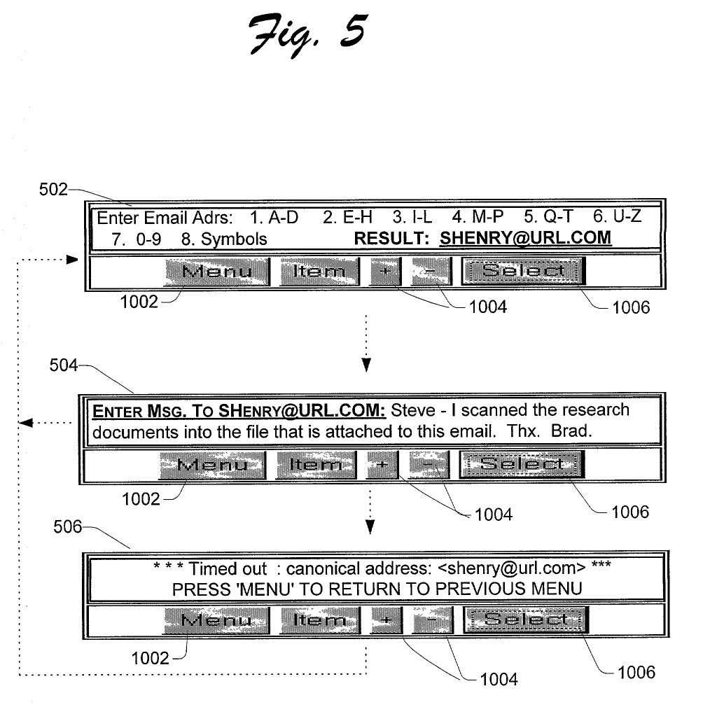

Search Module 206 queries the given LDAP or 3^{rd} party service to provide to the transmitter device 102 a list of email addresses for the user to select among. The transmitter device 102 receives back from the LDAP or 3^{rd} party service a hierarchical list or map of email addresses that are registered as being at the given server domain. The list can be sorted alpha-numerically, or by sections, departments, or categories for the given server domain. A display of the retrieved emails is then made on the touch sensitive menu screen 226 of the transmitter device 102. The user then selects from among the displayed email addresses using a ‘drill-down’ function of the menu, as discussed below with respect to FIG. 4. The drill-down menu format, which uses the hierarchical sorted or mapped organization of the retrieved list of email addresses, assists the user in narrowing down the displayed list to one or just a few email addresses of interest at the given server domain.

An example of a ‘drill-down’ function on a displayed menu with respect to the foregoing embodiment of the invention is now discussed with respect to FIG. 4. A menu screen 402 is displayed upon touch sensitive menu screen 226 of transmitter device 102. Menu screen 402 shows the result of a user selecting an email server from a list of email servers stored in memory 204 at menu documents 216. Thus, in accordance with still other aspects of the present invention, CPU 202 may be configured to maintain at least one email server address data list within memory 204. The email server address data list may include a plurality of email server addresses associated with a plurality of potential message data recipients.

The user can see each email server on the list by depressing virtual buttons 1004 to thereby move forward and backward through the email server address data list within memory 204. By depressing virtual button 1006, the user can select a particular displayed LDAP or external service. Thus, the LDAP service “RegentUniversity” would be selected when virtual button 1006 was depressed on menu screen 402 that is displayed upon touch sensitive menu screen 226. Menu screen 404 is then displayed. Menu screen 404 shows a hierarchical list of departments at Regent University as were received back from the LDAP service “RegentUniversity”. The user then depresses virtual buttons 1004 to move forward and backward through the hierarchical displayed list.

Once a desired department is displayed, the user depressed virtual button 1006 to select the desired department on menu screen 404. Menu screen 406 then appears and displays a further drilled down hierarchical list of categories within the desired departments at Regent University. The user moves forward and backward through the displayed categories by depressing virtual buttons 1004 and then depresses virtual button 1006 to select the category. Alphabetic and symbolic input can be made by the user on menu screen 408 by depressing virtual buttons 1004 to display yet another hierarchical list in menu screen 410. Menu screen 410 shows a limited range of email addresses corresponding to the alphabetic and symbolic input made by the user on menu screen 408. The user can move forward and backward through the displayed email addresses by depressing virtual buttons 1004. Once a desired email address is displayed, the user depresses virtual buttons 1004 to highlight the desired displayed email address. Then, the user depresses virtual button 1006 to select the highlighted email address.

After user has selected the highlighted email address as described above at the touch sensitive menu screen 226 on the transmitter device 102 so as to specify a particular email address, an email address validity check is performed in real time on the user selected email address by CPU 202 executing an Email Address Verification module 208. Email Address Verification module 208 will test the selected email address to make sure that the particular domain is active and that the email address at the particular domain will receive the delivery of a transmission. The test opens a connection with the email server “SMTP@RegentUnversity.Edu” that is associated with the selected email address. The email server is then queried about the validity of the particular email address of interest, as outlined earlier. This query can follow a well-known format, such as that implemented at “http://network-tool.com”. A response to the query by the email server at “SHenry@RegentUnversity.Edu” provides information on the validity of the email address. The transmitter device 102 then receives back the results of the real time verification check at Email Address Verification module 208. The result of the validation check can be displayed upon touch sensitive menu screen 226. The displayed result gives the user timely feedback prior to sending an email, thus avoiding the scenario of the user finding out much later that the email was sent from the transmitter device only to “bounce” as a non-delivery due to an invalid email address. By verifying a particular email address at a given server domain, the user of the transmitter device knows in advance whether or not the email address is valid prior to sending the document.

If the result of the email validation is positive, an email message screen 412 is displayed. The user can input alphabetic and symbolic characters to email message screen 412 by depressing virtual buttons 1004 to display a hierarchical list of available alphabetic and symbolic characters, and then select a displayed character by depressing virtual button 1006. When the user has made all of the desired input to email message screen 412, the user depresses virtual button 1006 twice to indicate that the message text is complete.

Once the message text has been selected upon menu screen 412 for transmission to a specific email address that has been determined to be valid, the user then places a set of documents into a sheet feeder device associated with transmitter device 102. The sheet feeder device then physically serves each sheet in the set of documents to scanning mechanism 224. CPU 202 then generates a bit map or other output that is a digital representation of the scanned documents. For example, the scanned object data may be included in the email message data as an attached file. The scanned object data may include Portable Document Format (PDF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc. Message data, including the message text displayed and selected upon menu screen 412, is addressed according to the validated email address. An email message, that includes the scanned object data in some manner, is then transmitted from transmitter device 102 to the validated email address over interconnecting network 106 or within intranet 101 as seen in FIG. 1.

If a desired email address that was selected at menu screen 410 is determined to be invalid during the execution of Email Address Verification module 208 by CPU 202, then menu 414 will be displayed upon touch sensitive menu screen 227. The user can depress a virtual menu button 1006 to go back to a previous menu and thereby initiate a different email address selection and validation process at menu screen 402.

In another embodiment of the invention, a Server Email Address Search Module 206 prompts the user on touch sensitive menu screen 226 to input a variety of information about the intended recipient of a transmission from the transmitter device 102. For instance, the user may key in a name, a Universal Resource Locator (URL), a company or organization name, and a telephone number of the intended recipient using the functionality provided by the touch sensitive menu screen 226 on the transmitter device 102. Input of this nature can be made using the alphabetic and symbolic input screens as seen and discussed above with respect to menu screen 408 in FIG. 4. A third party email search module 210 then interacts, preferably in back ground, with a third party Web email services provider seen in FIG. 3 at reference numeral 300. Third party email search module 210 queries third party Web email services provider 300 in order to obtain the closest match between the information input by the user and one or more email addresses located by the third party Web email services provider 300.

Third Party Email Search module 210 is implemented in software or firmware, and is configured to provide means to search via an Internet World Wide Web (Web) service hosted or otherwise provided by the third party Web email services provider 300. By way of example, a Yahoo! People Search™ Web service is provided by a Web site WWW.Yahoo.com where the email address of a person who had previously registered with the Yahoo! People Search™ Web service can be located. Third Party Email Search module 210 then coordinates a retrieval of the located closest matched email addresses back to transmitter device 102 for display of same upon the touch sensitive menu screen 226. An example of a resultant display for such a retrieval is seen in menu screen 410 in FIG. 4. The user then selects from among the displayed email addresses located by the third party Web email services provider 300. The validation check, message text input, and transmission of the email then proceeds as discussed above with respect to menu screens 410, 412, and 414 in FIG. 4.

In still a further embodiment of the invention, the Server Email Address Search Module 206 prompts a user to enter a URL of the third party Web email services provider 300 at the touch sensitive menu screen 226, such as is described above with respect to menu screen 408 of FIG. 4. Then, transmitter device 102 sends an email message that contains the URL of the third party Web email services provider 300. A server or host computer 112, as seen in FIG. 1, can provide the third party Web email services provider 300 and will preferably be situated outside of intranet 106 and in communication with interconnected network 110. An example of such a third party email server is seen at the domain “http://www.itraceyou.com” that is provided by a third party Web services entity. The email message is adapted so that, upon the opening of a connection to the server at the designated URL, a contact is initiated at the third party Web email services provider 300. A CGI (computer gateway interface) script or similar software running on the third party Web email services provider 300 causes the generation and transmission of an email message back to transmitter device 102, thereby confirming that the authenticity of the URL address on interconnected network 110. Third party email search module 210 then interacts, preferably in back ground, with the third party Web email services provider 300 in order to obtain a hierarchical list or map of email addresses that are registered at the designated URL. The list can be sorted alpha-numerically, or by sections, departments, or categories for the given server domain. A display of the retrieved emails is made on the touch sensitive menu screen 226 of the transmitter device 102, such as has been discussed above with respect to menu screen 410 of FIG. 4. The user then selects from among the displayed email addresses located by the third party Web email services provider 300. The validation check, message text input, and transmission of the email then proceeds as discussed above with respect to menu screens 410, 412, and 414 in FIG. 4.

In yet another embodiment of the invention, the Server Email Address Search Module 206 prompts the user to input the exact email address of the intended recipient of a transmission from the transmitter device 102. The user then keys in the exact email address using the functionality provided by the touch sensitive menu screen 226 on the transmitter device 102. An example of the user input is seen in FIG. 5 at menu screen 502. Menu screen 502 is presented by code executing in CPU 202 that allows the user to see alphabetic and symbolic characters by depressing virtual buttons 1004 to move forward and backward through a displayed hierarchical list of available alphabetic and symbolic characters. The code then executes a routine when the user selects a displayed character by depressing virtual button 1006. When the user has input all the characters of the desired email address as displayed upon menu screen 502, the user then depresses virtual button 1006 twice to indicate that the entry of the desired email address is complete. The validation check, message text input, and transmission of the email to the desired email address then proceeds as discussed above with respect to menu screens 410, 412, and 414 in FIG. 4, a correlative of which is seen, respectively, in menu screens 502, 504, and 506 in FIG. 5.

### Exemplary Embodiment of a Transmitter Device Email Validation

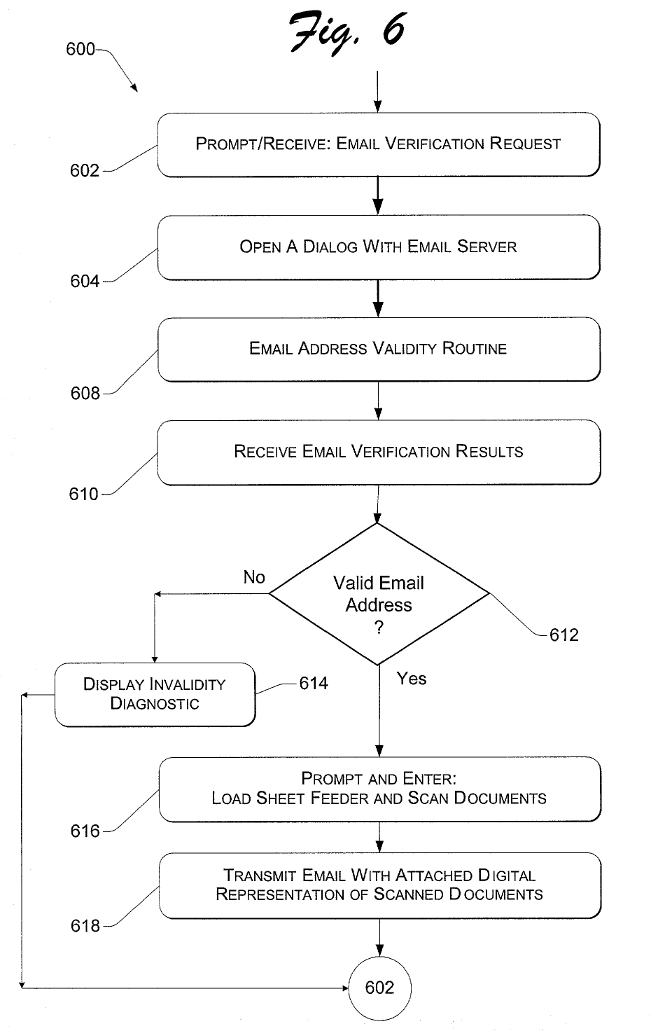

With this in mind, CPU 202 is configured to perform the operations described above. By way of further example, a flow diagram is depicted in FIG. 6 to illustrate certain exemplary functions that can be performed using CPU 202 and the other resources in transmitter device 102. Here, a process 600 is provided.

In step 602, transmitter device 102 displays a prompt upon touch sensitive menu screen 226. The prompt solicits input from a user for an email address, as discussed above with respect to FIGS. 4-5. The transmitter device 102 then receives input from the user. In order to display the prompt, it is preferably that the server module 214 of memory 204 in transmitter device 102 serves a menu page that is stored in menu documents 216 to CPU 202 for execution of code. The code being executed by CPU 202 effects a function to be performed by transmitter device 202, such as receiving input from a user that is entered upon touch sensitive menu screen 226, or the initiation of function by the user depressing a function related virtual button that is displayed upon touch sensitive menu screen 226. The code will preferably be executed in conjunction with an interpretation of the menu page. Note that in certain implementations, the menu page can be directly interpreted by code executing on CPU 202 without any prior storage in menu documents 216 or use of server module 214 in transmitter device 102.

At step 604, a dialog is opened with an email server designed in the input from the user. At step 606, the email address is determined to be valid or invalid using the services of a third party Web services entity with which transmitter device 102 is in communication through interconnecting network 110. At step 610, the result of the validation check is received at transmitter device 102 from the third party Web hosting entity.

At step 612, process 600 is moved to step 614 if the email address is determined to be invalid. A diagnostic is displayed to the user at step 612 and process 600 returns to step 602 for the user to input another email address for validation. Process 600 is moved to step 616 if the email address is determined to be valid. In step 616, using touch sensitive menu screen 226, a user can be prompted to load a sheet feeder with documents to be scanned for transmission, and well as to enter other user input data, such as, e.g., the subject of the email, the text or body of the email, etc. At step 618, message data is transmitted from the transmitter device in an email that contains the other user input data. The email will preferably be transmitted with an attached file that includes a digital representation of the scanned documents.

Accordingly, methods, apparatuses, systems, and programs are provided that allow for the discovery of an invalid email address prior to its actual use in the distribution of digital files as transmitted from a transmitter device. An email query module performs a real-time query of an email server to determine if a specified an email address is valid prior to transmitting to the email address from the transmitter device.

Thus, although some preferred embodiments of the various methods, apparatuses, systems, and programs of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. A method comprising:
receiving at a transmitter device a request for transmission of user message data to a requested email address on a network;
querying a network resource for the requested email address to determine if the requested email address is valid;
if the requested email address is invalid, displaying a diagnostic visible to the user; and
if the requested email address is valid:
optically scanning at the transmitter device at least one object to form corresponding object data; and
forming in said user message data said object data.

2. The method as defined in claim 1, wherein the network resource comprises an email server and the querying a network resource for the requested email address further comprises opening a connection with the email server.

3. The method as defined in claim 1, further comprising:
providing for display as a menu page on an input device, the menu page having selectable menu items that include an input for the requested email address; and
executing code associated with a selected menu item.

4. The method as defined in claim 3 wherein the input device comprises a touch screen display device.

5. The method as recited in claim 3, further comprising:
in response to executing the code, initiating a function of the transmitter device.

6. A method of sending message data from a transmitter device, the method comprising:
receiving input at a transmitter device of an email address on a network;
sending a request from the transmitter device for validation of the email address to a resource on the network;
receiving a validity status at the transmitter device from the resource for the email address; and
if the validity status is negative, displaying a diagnostic; and
if the validity status is positive:
addressing message data using said email address; and
transmitting said message data from the transmitter device to the email address.

7. The method as defined in claim 6, wherein the step of transmitting said message data from the transmitter device to the email address further comprises:
optically scanning at the transmitter device at least one object to form corresponding object data; and
forming in said user message data said object data.

8. The method as defined in claim 6, further comprising:
providing for display a menu page on an input device, the menu page having selectable menu items including input of the email address; and
executing code associated with a selected menu item.

9. The method as recited in claim 8, further comprising:
in response to executing the code, initiating a function of the transmitter device.

10. An apparatus capable of sending message data, the apparatus comprising:
an input device for receiving a requested email address;
logic operatively coupled to said input device, said logic being configured to form message data with said requested email address, said message data being at least a request from the apparatus for validation of the requested email address;
at least one network interface operatively coupled to said logic and configurable to:
send said message data to a network resource over the at least one communication network; and
receive from the network resource a validation status of the requested email address;
a module associated with said logic for processing the validation status and if the validity status is negative, display a diagnostic, and
if the validity status is positive, initiate a transmission routine to said email address.

11. The apparatus as recited in claim 10, wherein the initiate the transmission routine to said email address further comprises:
a subroutine to address said message data using said email address; and
a subroutine to transmit said message data to the email address.

12. The apparatus as recited in claim 11, further comprises a scanner mechanism; and wherein the initiate the transmission routine to said email address further comprises:
a subroutine to optically scan a document to form corresponding scanned object data; and
a subroutine to accept user input at the input device, said user input including user provided data; and
a subroutine to form said message data by combining said object data and said user provided data.

13. The apparatus as recited in claim 12, wherein the initiate the transmission routine to said email address further comprises a subroutine to display a prompt to scan the document.

14. The apparatus as recited in claim 10, further comprising memory that is operatively coupled to said logic, wherein said logic is further configured to maintain a plurality of network resources for email address validation within said memory.

15. The apparatus as recited in claim 14, wherein the plurality of network resources comprises one or more email address validation servers.

16. The apparatus as recited in claim 10, wherein:
said apparatus is included within a multiple function peripheral device; and
said multiple function peripheral device further includes a printer device that is operatively coupled to said logic.

17. The apparatus as recited in claim 16, wherein said logic is further configured to cause said printer device to selectively print at least one document corresponding to said message data.

18. The apparatus as recited in claim 10, wherein said input device for receiving a requested email address logic is a touch sensitive menu screen to present menu pages having one or more selectable menu items.

19. The apparatus as recited in claim 18, further comprising:
a virtual machine executing on the apparatus to interpret and execute code associated with a selected menu item.

20. The apparatus as recited in claim 19, wherein the code is configured to initiate a function of the apparatus.

21. The apparatus as recited in claim 19, wherein the code is selected from the group consisting of ChaiServer code, C++ code, and C# code, and JavaScript code.

22. The apparatus as recited in claim 18, wherein the menu pages identify and permit access to operable functions of the apparatus.

23. A transmitter device comprising:
means for transmitting message data to a network address on a network resource, wherein the message data includes a request for an email address validation of a network email address; and
means for processing valid and invalid responses received from the network resource for the request for the email address validation, and including:
for said valid response, means to transmit message data to the network email address; and
for said invalid response, means to display a diagnostic.

24. The transmitter device as defined in claim 23, further comprising:
means for receiving input of an email address;
means for optically scanning at least one object to form corresponding scanned object data; and
means for forming said scanned object data into said message data.

25. The transmitter device as recited in claim 23, wherein said means for receiving input of an email address is a touch sensitive menu screen to present menu pages having one or more selectable menu items.

26. The transmitter device as recited in claim 25, further comprising:
means to interpret and execute code associated with a selected menu item.

27. The transmitter device as recited in claim 26, wherein the code is configured to initiate a function.

28. The transmitter device as recited in claim 26, wherein the code is selected from the group consisting of JavaScript code, ChaiServer code, C++ code, and C# code.

29. The transmitter device as recited in claim 25, wherein the menu pages identify and permit access to operable functions of the transmitter device.

30. A transmitter device comprising:
means for receiving input of an email address;
means for querying a network resource to determine if the email address is valid;
where the email address is an invalid email address, means for displaying a visible diagnostic to the user; and
where the email address is a valid email address, means for:
optically scanning at least one object to form corresponding scanned object data; and
forming in user message data said scanned object data.

31. The transmitter device as defined in claim 30, further comprising:
means for transmitting the user message data to the email address.

32. A system comprising:
a network resource query module configured to query a network resource from a transmitter device over a network to ask whether an email address is valid;
a messaging module configured to send an email message from the network resource associated with the email address over the network to the transmitter device and relaying whether the email address is valid; and
a validity module, for use if the email address is valid, to:
optically scan at least one object to form corresponding scanned object data; and
form in said user message data said scanned object data.

33. The system of claim 32, wherein the network resource query module is additionally configured to open a connection with the network resource.

34. A processor-readable medium having processor-executable instructions thereon which, when executed by a processor of a transmitter device, cause the processor to:
query a network resource to determine if an email address is valid;
where the email address is an invalid email address, display a visible diagnostic to the user; and
where the email address is a valid email address:
optically scanning at least one object to form corresponding scanned object data; and
form in said user message data said scanned object data.

35. The processor-readable medium having processor-executable instructions thereon as defined in claim 34, wherein, when executed by the processor of the transmitter device, causes the processor further to:
transmit the user message data to the email address.
